(19) United States
(12) Patent Application Publication
(10) Pub. No.: US 2009/0242813 A1
(43) Pub. Date: Oct. 1, 2009

(54) Piezoelectric Valve

(75) Inventors: Atsuhiko Hirata, Yasu-shi (JP); Shungo Kanai, Omihachiman-shi (JP); Yuki Takahashi, Yasu-shi (JP)

Correspondence Address: DICKSTEIN SHAPIRO LLP, 1633 Broadway, NEW YORK, NY, 10019, US

(73) Assignee: Murata Manufacturing Co., Ltd., Nagaokakyo-shi (JP)

(21) Appl. No.: 12/485,407

(22) Filed: Jun. 16, 2009

Related U.S. Application Data
(63) Continuation of application No. PCT/JP2007/074789, filed on Dec. 25, 2007.

(30) Foreign Application Priority Data
Dec. 27, 2006 (JP) 2006-352032

(51) Int. Cl. F16K 31/02

(52) U.S. Cl. 251/129.01

(57) ABSTRACT

A piezoelectric valve includes a valve body having a valve chamber and a piezoelectric element that is bent and displaced by application of a voltage thereto and thereby opening and closing a channel opening. The piezoelectric element is a rectangular shape, and both ends thereof in the length direction are fixedly held by the valve body. The piezoelectric element has a first region in a central part and a second region adjacent to both ends thereof. The first region and the second region are bent and displaced oppositely by application of a voltage thereto such that the central part of the piezoelectric element opens and closes the channel opening.

### CROSS REFERENCE TO RELATED APPLICATIONS

The present application is a continuation of International Application No. PCT/JP2007/074789, filed Dec. 25, 2007, which claims priority to Japanese Patent Application No. JP2006-352032, filed Dec. 27, 2006, the entire contents of each of these applications being incorporated herein by reference in their entirety.

### FIELD OF THE INVENTION

The present invention relates to a piezoelectric valve, and more specifically, an active valve that uses a bending and deforming piezoelectric element as a valve member.

### BACKGROUND OF THE INVENTION

A power supply using a fuel cell for a mobile personal computer or other devices is being developed. One example fuel is a liquid fuel, such as methanol. Supplying the fuel to a reactor using a micropump causes the reactor to react the fuel with air and thus generate electric power. In such a fuel-cell system, even when the pump is shut down, an unintended flow of the fuel in the forward direction may occur because of gravity or other factors, an unnecessary fuel may be supplied to the reactor, and thus excessive electric power may be generated. Although the micropump has a check valve, the provision of a reliable forward stopping capability to the check valve itself is unfavorable to efficiency of the pump. To reliably block an unintended flow of the fuel, aside from the pump, an active valve is necessary.

Patent Document 1 discloses a piezoelectric valve that includes a valve body having an inlet and an outlet for fluid and a valve member having a plate piezoelectric element. FIG. 19 illustrates this structure, in which the outer area of a valve member 50 is fixedly held by a valve body 51. The application of a voltage to a piezoelectric element 52 bends the valve member 50 in the direction of the thickness, and the bending can open and close an inlet 53. Although an example in which the valve member 50 opens and closes the inlet 53 is described here, an outlet 54 may be opened and closed. Example types of the valve member 50 are the unimorph, as illustrated, in which the piezoelectric element 52 is attached on the central part of a single side of a metal diaphragm 55 and bimorph, in which a piezoelectric element is attached on both sides of a diaphragm.

In the case where the outer area of the valve member 50 is fixed held by the valve body 51, as described above, even when a voltage is applied to the piezoelectric element 52, because the outer area of the valve member 50 is constrained by the valve body 51, the displacement of the central part of the valve member 50 and that of the outer area cancel out each other, so the amount of the displacement of the central part is significantly small. Even if the voltage applied to the piezoelectric element 52 is increased, the maximum displacement is of the order, at most, of 20 μm. Therefore, fluid resistance passing through between a valve seat and the valve member 50 is large, and this is a cause of a loss of voltage.

Patent Document 2 discloses a piezoelectric valve in which the outer area of a valve member 56 having a piezoelectric element is supported by a valve body 57 without being constrained, the valve member 56 opens and closes an outlet 58, and the valve body 57 is provided with a communicating portion 59 such that the pressures of both sides of the valve member 56 are substantially the same, as illustrated in FIGS. 20(b) and 20(b). An inlet 60 is disposed so as to face the outlet 58. In this case, the outer area of the valve member 56 is merely supported by the valve body 57 without being constrained, so the central part of the valve member 56 can be displaced relatively largely. However, because the outer area of the valve member 56 is not securely held, the supply of a voltage to the piezoelectric element is difficult, and the reliability of the valve member 56 itself is decreased by continuous bending movement. In addition, because of the rigidity of the support portion is low, a problem exists in which the outlet 58 having a differential pressure cannot be closed (the closing pressure of the valve reduces).

Patent Document 3 discloses a gas flow control valve having the structure in which a rectangular piezoelectric unimorph is used as a valve member and the both ends of this unimorph in the length direction is supported on a valve body. In this case, to tolerate a displacement of the piezoelectric unimorph, both ends thereof are elastically held using elastomeric resin, such as silicone rubber. However, because the both ends are displaced every time the piezoelectric unimorph is driven, it is difficult to stably supply a voltage to the piezoelectric element, and a problem exists in which the reliability of the support portion is decreased by aging deterioration of the elastomeric resin. In addition, because the rigidity of the support part is low, a high closing pressure of the valve is unobtainable.

### Patent Document 1: Japanese Unexamined Patent Application Publication No. 62-28585

### Patent Document 2: Japanese Unexamined Patent Application Publication No. 3-223580

### Patent Document 3: Japanese Unexamined Patent Application Publication No. 62-283272

### SUMMARY OF THE INVENTION

It is an object of preferred embodiments of the present invention to provide a piezoelectric valve capable of concurrently solving problems of ensuring the reliability of a holding portion holding a valve member including a piezoelectric element and a valve body, increasing the amount of displacement (the degree of opening of the valve), and improving the closing pressure of the valve.

To achieve the object, the present invention provides a piezoelectric valve including: a valve body having an open/close channel opening; and a valve member including a plate piezoelectric element that is bent in a thickness direction thereof by an application of a voltage thereto and that opens and closes the open/close channel opening by bending. Each of both ends or an outer area of the piezoelectric element is fixedly held by the valve body. The piezoelectric element has a first region in a central part or a center and a second region adjacent to the both ends or the outer area, and the first region and the second region are bent and displaced oppositely by a voltage applied to the piezoelectric element.

Example types of traditional piezoelectric elements are the unimorph and the bimorph. In either case, the piezoelectric element is bent in a uniform direction by the application of a voltage thereto. When both ends of such a piezoelectric element are fixedly held by the valve body, the amount of displacement is significantly small. In contrast, when both ends of the piezoelectric element are supported so as to be freely displaceable, the amount of displacement is increased, but the reliability of the holding portion is decreased, and the closing pressure of the valve is also decreased. The present invention is characteristic in that each of both ends or an outer area of the piezoelectric element is fixedly held by the valve body, the piezoelectric element has a first region in a central part or a center and a second region at the both ends or the outer area, and the first region and the second region are bent and displaced oppositely by a voltage applied to the piezoelectric element. With such a configuration, the reliability of the holding portion between piezoelectric element and the valve body can be ensured, the amount of displacement can be increased, and the closing pressure of the valve can be further improved.

FIGS. 1(a) and 1(b) illustrate one example of an operation principle of the present invention. A piezoelectric element 1 forming a valve member is rectangular, and its both ends in the length direction are fixedly held on a valve body 2. The valve body 2 includes an open/close channel opening 3 and another channel opening 4. The open/close channel opening 3 is formed at a position that faces the central part of the piezoelectric element 1, whereas the channel opening 4 is formed at a position remote from the central part. Although not shown in the drawing, both side parts of the piezoelectric element 1 in the width direction (both side parts extending along a longer side) are not held by the valve body 2. Fixedly holding indicates securely fixing of both ends of the piezoelectric element 1 on the valve body 2 using, for example, curable adhesive. Because no relative displacement is present between the piezoelectric element 1 and the valve body 2 due to the fixing, electrical connection for supplying electricity to the piezoelectric element 1 is stable and simple, and a decrease in the reliability caused by aging deterioration is also small. In addition, because the rigidity of the holding portion can be high, the closing pressure of the valve can be high. Therefore, the channel opening having a high differential pressure can be opened and closed. Here, the open/close channel opening 3 is an outlet, and the channel opening 4 is an inlet. However, the open/close channel opening 3 may be an inlet, and the channel opening 4 may be an outlet. It is not limited to a normally open valve, and it may be a normally close valve.

FIG. 1(b) illustrates a state in which a direct-current voltage is applied to the piezoelectric element 1, and the border between a first region S1 and a second region S2 is indicated by broken lines. The border is a point of inflection, at which the curvature changes. This point of inflection is positioned inside an area where the piezoelectric element 1 is fixed by the valve body 2. When both ends of the piezoelectric element 1 are fixed, the amount of displacement of the central part is significantly small in a traditional piezoelectric element that bends in a uniform direction, whereas the amount of displacement of the central part is large in the piezoelectric element 1 according to the present invention because the first region S1 adjacent to the center and the second region S2 adjacent to both ends bend oppositely. For example, when the first region S1 adjacent to the center bends upwardly convexly, the second region S2 bends downwardly convexly. Therefore, the amount of displacement of the first region S1 is added to the amount of displacement of the second region S2, and thus the amount of displacement of the central part can be large. As a result, the distance between the central part of the piezoelectric element 1 and the channel opening 3 (the degree of opening of the valve) can be large during the opening of the valve, so the fluid resistance in a state where the valve is opened can be reduced.

According to a preferred embodiment, the piezoelectric element may preferably have a rectangular shape, both ends of the piezoelectric element in a length direction may preferably be fixedly held by the valve body, and both side parts of the piezoelectric element in a width direction may preferably be not held by the valve body. The piezoelectric element (valve member) usable in the present invention is not limited to a rectangular shape, but may also be of disc shape. In the case where only both ends of a rectangular piezoelectric element in the length direction are fixed held on the valve body, the amount of displacement of bending in the central part is very larger, compared with when all outer areas of a disk-shaped piezoelectric element are held. Therefore, the degree of opening of the valve can be largely changed, so the opening/closing performance can be improved. Increasing the ratio between the long side and the short side of the piezoelectric element can increase the displacement in the piezoelectric element while reducing the footprint. In the case of a rectangular piezoelectric element, the maximum amount of displacement is substantially determined by the length of the long side of the piezoelectric element.

When a rectangular piezoelectric element is used, it is preferable that a communicating portion for fluid be provided between the valve body and both ends in the width direction of the piezoelectric element such that a region adjacent to the front side of the piezoelectric element and a region adjacent to the back side thereof communicate with each other thorough the communicating portion. In this case, because the region adjacent to the front side of the piezoelectric element and the region adjacent to the back side thereof have the same pressure, no external force other than the fluid pressure on the channel openings is exerted on the piezoelectric element, and therefore, the valve can be closed with a relatively small driving force. In the case of the structure in which the outlet of the channel openings is opened and closed by the piezoelectric element, because the piezoelectric element can be pressed against the outlet with the back pressure from the inlet having a high pressure during the state of closing the valve, leakage of fluid can be prevented even with a relatively small driving force. As a result, it is necessary to continue applying a large voltage to maintain a state in which the valve is closed.

In the case where a rectangular piezoelectric element is used, the first region may preferably be present in a central part of a portion of the piezoelectric element in the length direction, the portion being not fixed by the valve body, the second region may preferably be present more adjacent to the both ends of the piezoelectric element in the length direction than the first region, and the first region may preferably be open and closes the open/close channel opening. FIGS. 2(a) and 2(b) illustrate a variety of forms of a piezoelectric element having the first region S1 and the second region S2. FIG. 2(a) illustrates a first example of the piezoelectric element 1 having only the first region S1 and the second region S2, in which a part of the outer area of the second region S2 is held by the valve body 2. FIGS. 2(b) to (d) illustrate examples in which an intermediate region S3 that does not bend spontaneously is formed outside the second region S2. The intermediate region S3 is the portion where no electrode is formed, the portion where although an electrode is formed no polarization is present, or the portion where although an electrode is formed a voltage is not applied. When a voltage is applied to the piezoelectric element (when the first region and second region bend), the intermediate region S3 does not bend and not change its shape. FIG. 2(b) illustrates an example in which the border between the intermediate region S3 and the second region S2 is positioned outside an inner edge 2a of the valve body 2; FIG. 2(c) illustrates an example in which the border between the intermediate region S3 and the second region S2 substantially matches with the inner edge 2a of the valve body 2; and FIG. 2(d) illustrates an example in which the border between the intermediate region S3 and the second region S2 is positioned inside the inner edge 2a of the valve body 2. When only the intermediate region S3 is held by the valve body 2, as in FIGS. 2(c) and 2(d), because the bent part of the piezoelectric element 1 is not forcibly constrained, the piezoelectric element 1 can be displaced efficiently.

According to a preferred embodiment, the valve body can include: a bottom board having a rectangular planar shape and being wider than the piezoelectric element; a first frame being disposed on an upper surface of the bottom board and having a rectangular frame shape and an inner width dimension being larger than that of the piezoelectric element; a pair of retainer plates being disposed on an upper surface of both side parts of the first frame in the width direction and having substantially the same thickness as in the piezoelectric element; a second frame being disposed on an upper surface of the piezoelectric element and the retainer plates and having substantially the same shape as the first frame; and a top board being disposed on an upper surface of the second frame. The both ends of the piezoelectric element in the length direction can be sandwiched between both ends of the first frame and the second frame in the length direction. The bottom board, the first frame, the piezoelectric element, the retainer plates, the second frame, and the top board can be laminated and bonded, and a valve chamber for allowing the piezoelectric element to be displaced can be present between the bottom board and the top board. In such a way, all the components forming the valve body are formed from a planar member, and the valve body is constructed by lamination of theses components bonded together. Therefore, the cost of manufacturing can be reduced, and the thinner (lower-profile) piezoelectric valve can be achieved.

According to a preferred embodiment, at least a surface of the piezoelectric element, the surface facing a space of the valve body through which fluid passes, may preferably be covered with a protective layer that does not substantially constrain the displacement of the piezoelectric element. If fluid (in particular, liquid) comes into contact with the piezoelectric element, corrosion and reduction in insulation properties is likely to occur, and additionally it may produce a problem of, for example, cracking caused by contact with and separation from a portion (valve seat) of the channel opening in contact with the valve member. If the surface of the piezoelectric element is covered with a protective layer that does not substantially constrain a displacement of the piezoelectric element, it is possible to solve the above problem. As the protective layer, a resin sheet or rubber sheet may be attached, or alternatively, surface treatment or resin coating may be applied. Preferably, the protective layer may be a thin layer having a minimum Young's modulus. The protective layer can not only prevent shorts and electrode migration caused by liquid coming into direct contact with the piezoelectric element but also serve as a sealant for preventing leakage of liquid.

The protective layer may preferably include a pair of upper and lower films bonded such that the piezoelectric element is disposed therebetween, each of the films may preferably have a slit forming the communicating portion at a portion extending along the both side parts of the piezoelectric element in the width direction, and an outer area of the film may preferably be sandwiched between the retainer plates and the second frame. In this case, a resin film can be used as the protective layer. The provision of a slit that also acts as a communicating portion to the film can facilitate a displacement of the piezoelectric element and can also ensure the sealing function by sandwiching the outer area of the film between the retainer plate and the second frame.

Moreover, the valve body may preferably includes: a bottom board having a rectangular planar shape and being wider than the piezoelectric element; a first frame being disposed on the bottom board and having a rectangular frame shape and an inner width dimension being larger than that of the piezoelectric element; a first protective board being disposed on the first frame, having a pair of slits in an area extending along the both side parts of the piezoelectric element in the width direction; the piezoelectric element disposed on a central upper surface of the first protective board; a pair of retainer plates being disposed on the first protective board and in the vicinity of the both side parts of the piezoelectric element in the width direction, having slits corresponding to the slits of the first protective board, and having a thickness substantially the same as the piezoelectric element; a second protective board being disposed on the piezoelectric element and the retainer plates and having the same shape as the first protective board; a second frame being disposed on the second protective board and having substantially the same shape as the first frame; and a top board being disposed on the second frame. The both ends of the piezoelectric element in the length direction may preferably be sandwiched between both ends of the first frame and the second frame in the length direction with the first and second protective board, and the bottom board, the first frame, the first protective board, the piezoelectric element, the retainer plates, the second protective board, the second frame, and the top board may preferably be laminated in sequence and bonded. Also in this case, the piezoelectric valve can be thinner, as in the aforementioned piezoelectric valve, and because the pair of retainer plates and the piezoelectric element are sandwiched between the upper and lower protective boards, the sealing properties of the periphery of the piezoelectric element and resistance to pressure are improved.

In the case of the laminated piezoelectric element in which a plurality of piezoelectric ceramic layers are laminated, it is advantageous in that a large displacement and a large driving force are obtainable even with a low voltage, compared with the unimorph or bimorph one in which a piezoelectric element(s) are attached to a metal plate. However, its mechanical strength is lower, so it is likely to have cracking caused by drop impact. Covering the surface of the piezoelectric element with the protective layer enables the highly reliable valve member.

As the piezoelectric element according to the present invention, the laminated piezoelectric element is preferable. It may have a structure in which a plurality of piezoelectric layers that has been sintered and polarized in advance are attached using adhesive or one in which piezoelectric layers being a ceramic green sheet are laminated and crimped such that an electrode is sandwiched therebetween and polarization is performed after sintering. One common structure used in the former case is the structure in which two single-panel piezoelectric bodies are attached. In this case, because the fabrication of the piezoelectric body is very easy, it can be constructed inexpensively. In the latter case, because the piezoelectric element can be thinner and a plurality of layers can be laminated, a driving voltage can be lower than the piezoelectric body having the same thickness.

### ADVANTAGES OF PREFERRED EMBODIMENTS OF THE INVENTION

According to the present invention, because the first region (adjacent to the center) and the second region (adjacent to both ends) bent oppositely, even when both ends of the piezoelectric element are fixedly held by the valve body, a large amount of displacement is obtainable in the central part of the piezoelectric element and the fluid resistance during the opening of the valve can be reduced. Because both ends of the piezoelectric element are fixedly held by the valve body, the reliability in the holding portion for the piezoelectric element and the valve body can be ensured, and a voltage can be stably supplied to the piezoelectric element. Additionally, because the rigidity of the holding portion is high, the advantage of being able to open and close the channel opening having a differential pressure (of a high closing pressure of the valve) is obtained.

### BRIEF DESCRIPTION OF THE DRAWINGS

FIGS. 1(a) and 1(b) are sectional views that illustrate an operation principle of a piezoelectric valve according to the present invention; wherein FIG. 1(a) illustrates an undriven state (valve is opened); and FIG. 1(b) illustrates a driven state (valve is closed).

FIGS. 2(a) to 2(d) illustrate schematic section views that show several examples of a basic structure of the piezoelectric valve according to the present invention.

FIG. 3 is a general perspective view of the piezoelectric valve according to an Example 1 of the present invention.

FIG. 4 is an exploded perspective view of the piezoelectric valve according to the Example 1 of the present invention.

FIG. 5 is a section view taken along the line V-V of FIG. 3.

FIG. 6 is a section view taken along the line VI-VI of FIG. 3.

FIGS. 7(a) and 7(b) illustrate an assembly structure of a valve member.

FIG. 8 is a section view taken along the line V-V of FIG. 3 when the valve is closed.

FIG. 9 is a section view taken along the line V-V of FIG. 3 when the valve is opened.

FIG. 10 is an exploded perspective view of the piezoelectric valve according to an Example 2 of the present invention.

FIG. 11 is a cross-sectional view, looking from the perpendicular direction of a piezoelectric element of the piezoelectric valve illustrated in FIG. 10.

FIGS. 12(a) and 12(b) illustrate an assembly structure of the valve member of the piezoelectric valve illustrated in FIG. 10.

FIG. 13 is a schematic section view of the piezoelectric element used in the piezoelectric valve according to a first example of the present invention.

FIGS. 14(a) and 14(b) are model diagrams when a displacement is present according to a comparative example and the present invention, respectively.

FIG. 15 is a schematic section view of the piezoelectric element used in the piezoelectric valve according to a second example of the present invention.

FIG. 16 is a schematic section view of the piezoelectric element used in the piezoelectric valve according to a third example of the present invention.

FIG. 17 is a schematic section view of the piezoelectric element used in the piezoelectric valve according to a fourth example of the present invention.

FIG. 18 is a section view of the piezoelectric valve according to an Example 3 of the present invention.

FIG. 19 is a section view of one example of a traditional piezoelectric valve.

FIGS. 20(a) and 20(b) are section views of another example of a traditional piezoelectric valve.

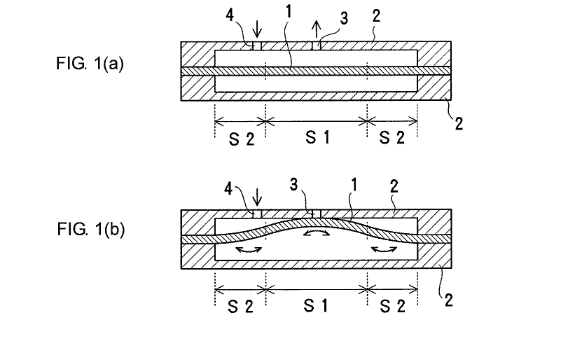

### REFERENCE NUMERALS

A, B piezoelectric valve
10 valve body
11 bottom board
12 first frame
13 retainer plate
14 second frame
15 top board
15a outlet (open/close channel opening)
15b inlet
16 valve chamber
17 valve sheet
20 valve member
21 piezoelectric element
30, 31 insulating film
32, 33 protective board
34, 35 retainer plate
S1 first region
S2 second region

### DETAILED DESCRIPTION OF THE INVENTION

Preferred embodiments of the present invention will be described below on the basis of examples.

### Example 1

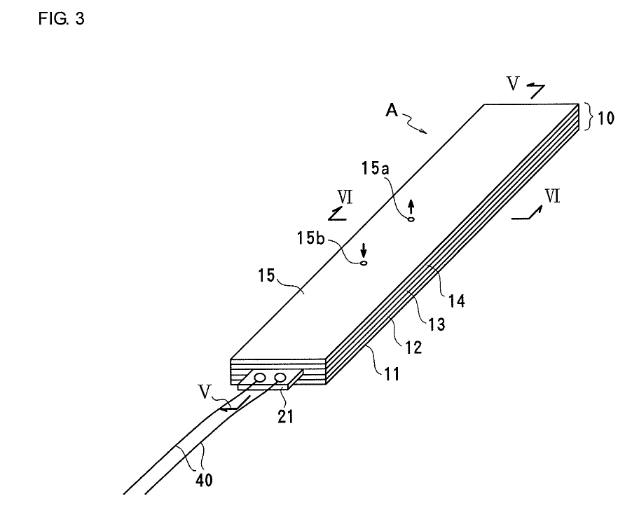

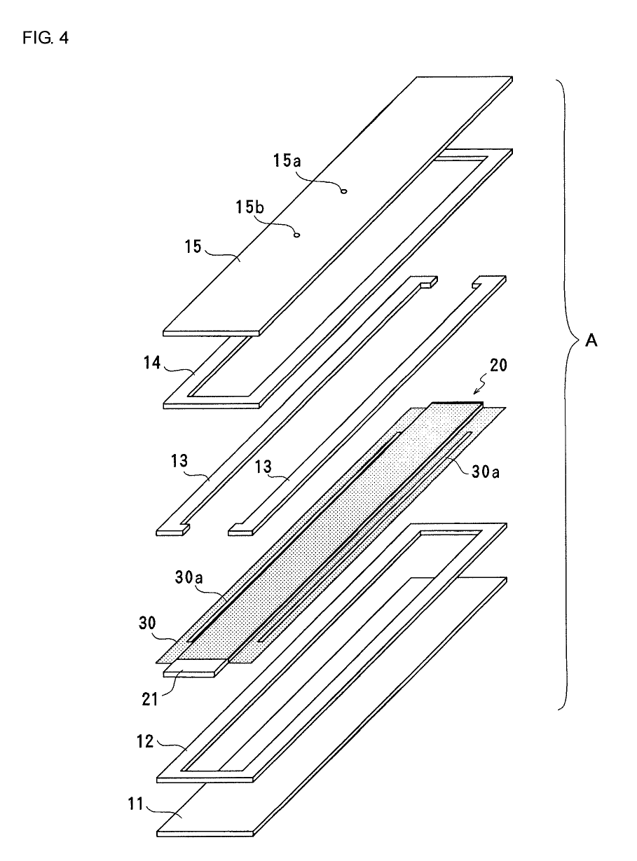

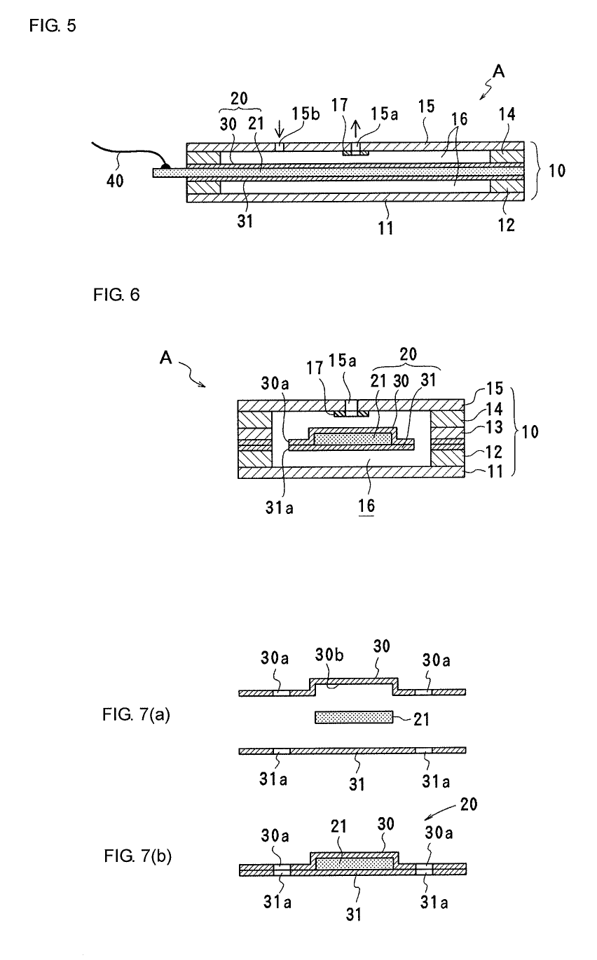

FIGS. 3 to 6 illustrate an Example 1 of a piezoelectric valve. FIG. 3 is a general perspective view of a piezoelectric valve according to the present invention. FIG. 4 is an exploded perspective view of the piezoelectric valve. FIG. 5 is a section view taken along the line V-V of FIG. 3. FIG. 6 is a section view taken along the line VI-VI of FIG. 3.

The piezoelectric valve A according to the present example is used as an active valve for controlling flow of fluid, such as methanol and includes a valve body 10 and valve member 20. The valve body 10 is formed from a highly rigid material, such as a metal material or a resin material. The valve member 20 includes a piezoelectric element 21. As illustrated in FIG. 4, the valve body 10 includes a bottom board 11 having a rectangular planar shape and being wider than the piezoelectric element 21, a first frame 12 being disposed on the upper surface of the bottom board 11 and having a rectangular frame shape and an inner width dimension being larger than that of the piezoelectric element 21, a pair of retainer plates 13 being disposed on the upper surface of both sides of the first frame 12 along the long side thereof and having substantially the same thickness as the piezoelectric element 21 and having the shape of U, a second frame 14 being disposed on the upper surface of the piezoelectric element 21 and the retainer plates 13 and having substantially the same shape as the first frame 12, and a top board 15 disposed on the upper surface of the second frame 14.

In this example, the top board 15 has an outlet 15a at its central position and an inlet 15b at a position adjacent to one side. However, the inlet 15b may be formed at the central position, and the outlet 15a may be formed at a position adjacent to one side. The inlet and outlet may be formed in the bottom board 11. One of the inlet and outlet may be formed in the top board 15, and the other may be formed in the bottom board 11. The components 11 to 15 are laminated and bonded such that the piezoelectric element 21 is positioned inside, thus forming the valve body 10. A valve chamber 16 allowing the piezoelectric element 21 to be displaced is formed between the bottom board 11 and the top board 15. A rubber valve sheet 17 (see FIGS. 5 and 6) is fixed on the periphery of the outlet 15a facing the valve chamber 16. Although it is possible that the valve sheet 17 is disposed on at a position that is adjacent to the piezoelectric element 21 and that faces the outlet 15a, when the valve sheet 17 is disposed on the periphery of the outlet 15a facing the valve chamber 16 in advance, even if, for example, the diameter of the outlet 15a is very small, because plane alignment of the valve sheet 17 and the outlet 15a can be performed in advance, the valve sheet 17 is accurately positioned at the contact between the piezoelectric element 21 and the outlet 15a during the operation of the valve. Accordingly, the outlet 15a can be reliably closed by the piezoelectric element 21.

The piezoelectric element 21 has a rectangular planar shape by use of a piezoelectric ceramic laminated structure, which will be described below. The periphery of an area of the piezoelectric element 21 that faces the valve chamber 16 is covered with insulating films 30 and 31 to avoid the piezoelectric element 21 from being contact with fluid. The insulating films 30 and 31 are thin soft layers that do not substantially constrain a displacement of the piezoelectric element 21 and may preferably have high gas barrier properties and be formed from a material that is not eroded by fluid. Both ends of the piezoelectric element 21 in the length direction with the insulating films 30 and 31 are arranged on the upper surface of both ends in the length direction of the first frame 12 such that the piezoelectric element 21 and the insulating films 30 and 31 bridge a gap between the both ends of the first frame 12. The top board 15 is bonded from thereabove with the retainer plate 13 and the second frame 14 disposed therebetween, and thus the portion other than both ends of the piezoelectric element 21 is arranged in the sealed valve chamber 16 so that it can be displaced. At this time, one edge of the piezoelectric element 21 that is not covered with insulating films 30 and 31 is exposed from the valve body 10, and this exposed portion is connected to a feeding wire 40 (see FIG. 3).

The insulating films 30 and 31 of this example are wider than the piezoelectric element 21 and longer than the piezoelectric element 21. That is, their outer shape is substantially the same as the bottom board 11 and the first frame 12. Each of the insulating films 30 and 31 has slit communicating holes 30a and 31a at both side parts in the width direction (both side parts along the long side), and the communicating holes 30a and 31a lie within the valve chamber 16. The length of each of the communicating holes 30a and 31a is substantially the same as the dimension of the valve chamber 16 in the longitudinal direction. Therefore, both ends in its length direction of the piezoelectric element 21 is fixedly held by the valve body 1, whereas both side parts in the width direction thereof can be freely displaced. Additionally, the pressure of fluid that entered through the communicating holes 30a and 31a from the inlet 15b is exerted on both the front side of the piezoelectric element 21 (the side facing the outlet) and the back side, the pressures of both sides of the piezoelectric element 21 are the same, so the outlet 15a can be closed with a relatively small driving force. In particular, in the case of the structure in which the outlet 15a is opened and closed by the piezoelectric element 21, because the piezoelectric element 21 is pressed against the outlet 15a by the back pressure from the inlet 15b having a high pressure during the state of closing the valve, leakage of fluid can be reliably prevented. The insulating films 30 and 31 cover at least an area of the piezoelectric element 21 that faces the valve chamber 16, and it is not necessary that they have substantially the same shape as the first frame 12, as in the aforementioned example.

FIGS. 7(a) and 7(b) illustrate one example of an assembly structure of the piezoelectric element 21 forming the valve member 20 and the insulating films 30 and 31. As illustrated in FIG. 7(a), the insulating films 30 and 31 are arranged at upper and lower positions, respectively, such that the piezoelectric element 21 is disposed therebetween. The insulating film 30 at the upper position has a recess 30b for allowing the piezoelectric element 21 to fit therein. By bonding of both the insulating films 30 and 31 such that the slits 30a and 31a match with each other, the valve member 20 in which the periphery of the piezoelectric element 21 is sealed is obtainable.

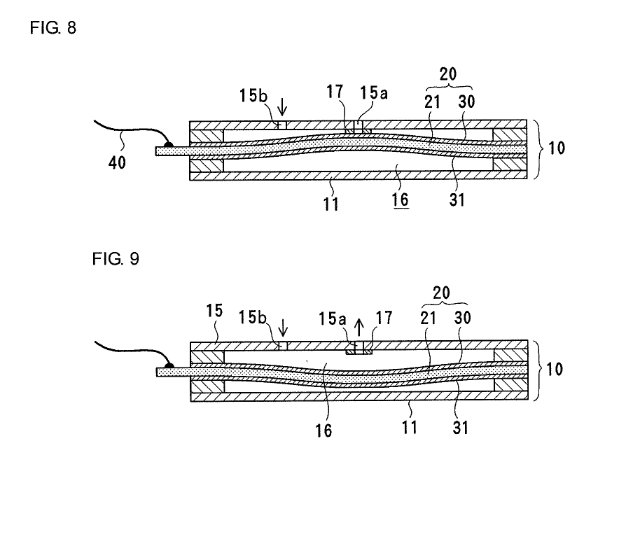

FIG. 8 illustrates a state where a direct-current voltage is applied to the piezoelectric element 21 in a direction in which the central part thereof becomes convex upward. The central part of the piezoelectric element 21 is displaced and is seated on the valve sheet 17, and the piezoelectric element 21 can reliably close the outlet 15a. Even when a high pressure is exerted from the inlet 15b during the state of closing the valve, that pressure is exerted on both the upper side of the piezoelectric element 21 and the lower side. Therefore, the piezoelectric element 21 is urged in the direction of closing the valve, so the state where the valve is closed can be maintained without the application of a high voltage.

FIG. 9 illustrates a state where a direct-current voltage is applied to the piezoelectric element 21 in a direction in which the central part thereof becomes convex downward. Displacing the piezoelectric element 21 downward increases the distance between the outlet 15a and the piezoelectric element 21 and expands the channel space, so the fluid resistance when the valve is opened can be reduced. The application of a voltage such that the piezoelectric element 21 becomes convex downward, as illustrated in FIG. 9, is not necessarily required. It is sufficient that the piezoelectric element 21 is changed to two positions: the state where a voltage is applied in the direction in which the piezoelectric element 21 becomes convex upward (FIG. 8) and the state where no voltage is applied (FIG. 5).

### Example 2

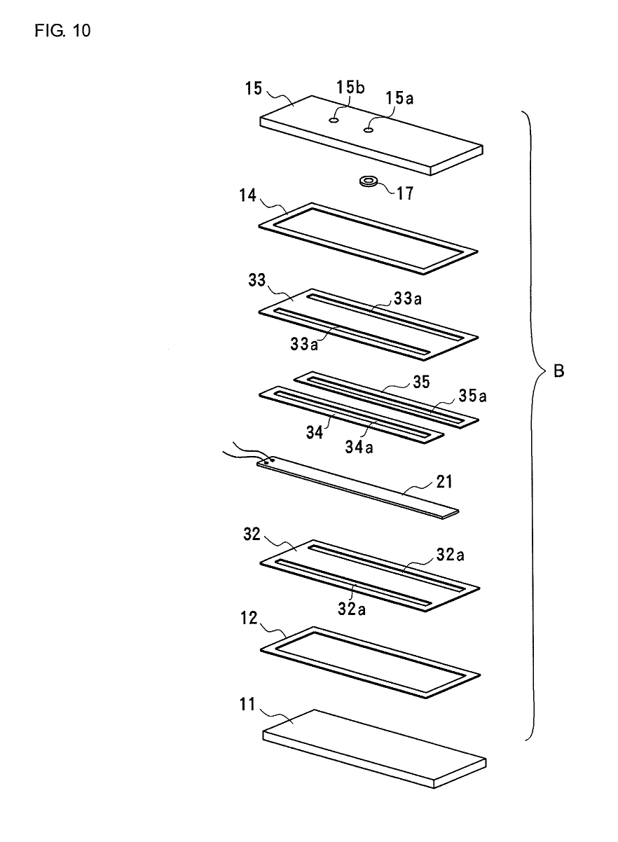

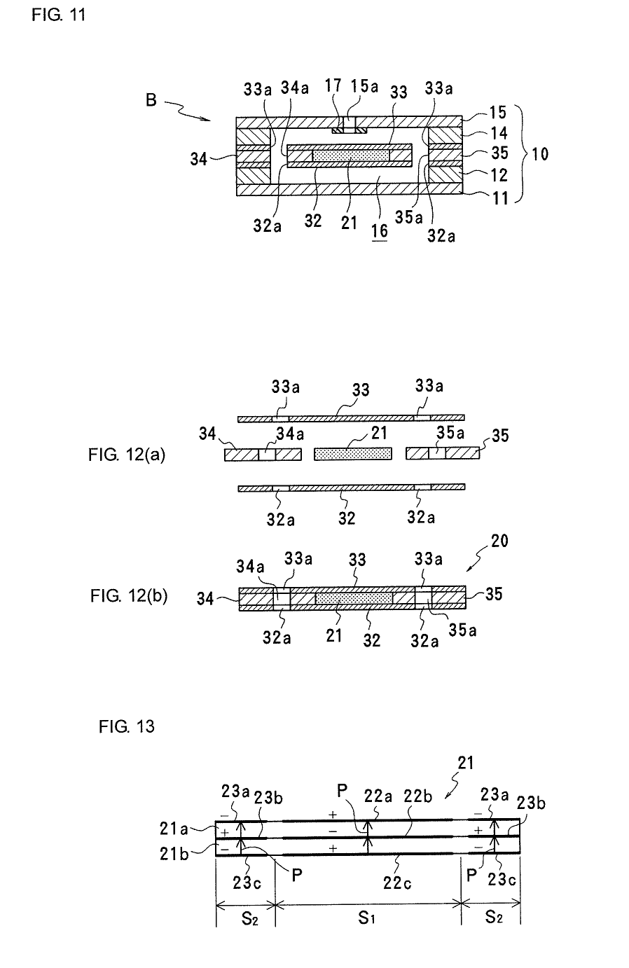

FIGS. 10 and 11 illustrate an Example 2 of the piezoelectric valve. FIG. 10 is an exploded perspective view of a piezoelectric valve B, and FIG. 11 is a cross-section view thereof. The same reference numerals are used in the parts common to those in the Example 1, and the redundant description is omitted.

The bottom board 11, the first frame 12, the piezoelectric element 21, the second frame 14, and the top board 15 used in the piezoelectric valve B of this example are the same as in the piezoelectric valve A. A first protective board 32 composed of a resin sheet is disposed on the first frame 12. The outer shape of the first protective board 32 is substantially the same as the bottom board 11. The first protective board 32 has a pair of slits 32a in an area extending along both side parts in the width direction of the piezoelectric element 21. The piezoelectric element 21 is disposed on the upper surface at the central part of the first protective board 32. A pair of retainer plates 34 and 35 is disposed on the first protective board 32 in the vicinity of both sides of the piezoelectric element 21 in the width direction. The retainer plates 34 and 35 are a resin plate having a thickness substantially equal to that of the piezoelectric element 21 and have slits 34a and 35a, respectively, corresponding to the slits 32a of the first protective board 32. Because the piezoelectric element 21 and the retainer plates 34 and 35 are disposed on the first protective board 32, their respective upper surfaces are flush with each other. A second protective board 33 is disposed on these flush upper surfaces. The second protective board 33 is composed of a resin sheet having the same shape as the first protective board 32 and has a pair of slits 33a corresponding to the slits 32a. The second frame 14 is disposed on the second protective board 33, and the top board 15 is disposed thereon.

The bottom board 11, the first frame 12, the first protective board 32, the piezoelectric element 21, the retainer plates 34 and 35, the second protective board 33, the second frame 14, the top board 15 are laminated in sequence and form the valve body 10. One example of a laminating method can be one that bonds them using adhesive. They may be joined to each other by laser welding or heat welding.

In this example, the protective boards 32 and 33 and the retainer plates 34 and 35 are disposed so as to be in contact with the upper and lower surfaces and both sides of the piezoelectric element 21. Because there is no need to provide the protective boards 32 and 33 with a recess, they can be formed in a planar shape, so the cost can be reduced. Additionally, because the overall circumferences of the protective boards 32 and 33 are in close contact with the first frame 12 and the second frame 14, respectively, in a planar manner, even if a high pressure is applied to the valve chamber 16, leakage of liquid can be reliably prevented, so it is advantageous in that resistance to pressure is improved. A resin material such as thermoplastic resin whose interference with a displacement of the piezoelectric element 21 is minimum is used in the protective boards 32 and 33 and the retainer plates 34 and 35. In particular, the formation of the protective boards 32 and 33 and the retainer plates 34 and 35 from the same material offers a favorable bonding capability.

FIGS. 12(a) and 12(b) illustrate an assembly structure of the piezoelectric element 21, the protective boards 32 and 33, and the retainer plates 34 and 35 according to the Example 2. As illustrated in FIG. 12(a), the piezoelectric element 21 and the retainer plates 34 and 35 are arranged, and the protective boards 32 and 33 are disposed therebelow and thereabove, respectively, so as to sandwich the piezoelectric element 21 and the retainer plates 34 and 35 therebetween. The protective boards 32 and 33 and the retainer plates 34 and 35 are joined to each other such that the slits 32a, 33a, 34a, and 35a are aligned. Therefore, the valve member 20 in which the periphery of the piezoelectric element 21 is sealed, as illustrated in FIG. 12(b), is obtainable. In this case, the protective boards 32 and 33 can be planar, and it is unnecessary to form a recess therein. Even when a gap is present between the both side parts of the piezoelectric element 21 in the width direction and the retainer plates 34 and 35, as long as the protective boards 32 and 33 and the retainer plates 34 and 35 are joined, the sealing capability is not affected.

FIG. 13 illustrates one example of a specific structure of the piezoelectric element 21. The piezoelectric element 21 is a bimorph actuator in which electrodes are formed on both sides of two single-panel piezoelectric bodies 21a and 21b composed of piezoelectric ceramic polarized uniformly in the same direction as a whole are bonded together. The electrodes are drawn out such that, after boding, there is continuity between electrodes indicated by plus signs in FIG. 13 and there is continuity between electrodes indicated by minus signs. Interlayer electrodes and surface electrodes are divided into central electrodes 22a to 22c and end electrodes 23a to 23c. The region of the central electrodes 22a to 22c is the first region S1, and the region of the end electrodes 23a to 23c is the second region S2. The polarization direction of the first region S1 and that of the second region S2 are the same (indicated by the arrows P). The ratio between the size of the first region S1 and that of the second region S2 can be freely selected in accordance with the valve characteristics. When a direct-current voltage is applied in a way indicated by the plus and minus signs in FIG. 13, the second region S2 changes its shape upwardly convexly and the first region S1 changes its shape downwardly convexly. When the voltage is reversed, the second region S2 changes its shape downwardly convexly and the first region S1 changes its shape upwardly convexly.

As described above, both ends of the piezoelectric element 21 (containing a part of the second region S2) are fixedly held by the valve body 10. For a typical piezoelectric element, if its both ends are fixed, even when a voltage is applied, the displacements of the central part and both ends of the piezoelectric element cancel each other out, the piezoelectric element is not substantially displaced. According to the present invention, because the central part (first region S1) and both ends (second region S2) of the piezoelectric element 21 bend and change their shapes oppositely, even when both ends are fixedly supported, the central part can be sufficiently displaced. Accordingly, the closing pressure of the valve of the piezoelectric element 21 and the outlet 15a (valve sheet 17) during the closing of the valve can be ensured, and the distance between the central part of the piezoelectric element 21 and the outlet 15a can be ensured during the opening of the valve. The resistance of fluid passing through the outlet 15a can be reduced.

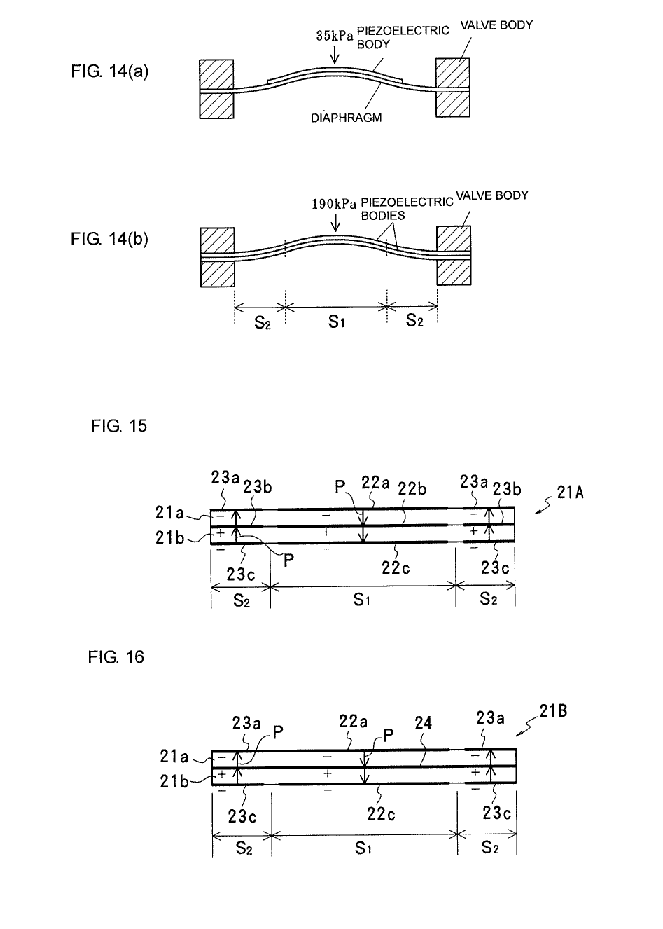

Next, to examine the effectiveness of the present invention, a simulation was performed using a comparative example and the present invention with respect to the closing pressure of the valve and the amount of displacement of the central part. FIG. 14(a) illustrates the comparative example, and FIG. 14(b) illustrates the present invention.

### Comparative Example

A unimorph piezoelectric element in which a piezoelectric body (PZT) of 30 mm×4 mm×0.1 mm is bonded to a stainless diaphragm of 20 mm×4 mm×0.1 mm was used, and both ends thereof in the length direction was fixed. The length dimension 30 mm is the dimension exclusive of the fixing portion. A direct-current voltage of 30 V was applied to the piezoelectric body in a direction in which the central part of the piezoelectric element was displaced upward. When a pressure of 35 kPa was applied to a region of φ0.6 mm in the central part in a direction opposite to the direction of displacement of the piezoelectric element, as indicated by the arrow, the central part had a displacement of approximately 20.4 μm. As a result, in the case where it is designed that the distance between the surface of the piezoelectric element and the channel opening when no voltage is applied is 20 μm, the channel opening can be closed against a differential pressure of approximately 35 kPa at the maximum. When only a voltage was applied and a pressure in the opposite direction was not applied to the central part, the amount of displacement of the central part was 28.5 μm.

—Present Invention—

A bimorph piezoelectric element in which two piezoelectric bodies (PZT) each having the dimensions of 30 mm×4 mm×0.1 mm are bonded together was used, and both ends thereof in the length direction was fixed. The length dimension 30 mm is the dimension exclusive of the fixing portion. A direct-current voltage of 30 V was applied to each of the piezoelectric bodies in a direction in which the central part of the piezoelectric element was displaced upward. When a pressure of 190 kPa was applied to a region of φ0.6 mm in the central part in a direction opposite to the direction of displacement of the piezoelectric element, as indicated by the arrow, the central part had a displacement of approximately 20.7 μm. As a result, in the case where it is designed that the distance between the surface of the piezoelectric element and the channel opening when no voltage is applied is 20 μm, the channel opening can be closed against a differential pressure of approximately 190 kPa at the maximum. When only a voltage was applied and a pressure in the opposite direction was not applied to the central part, the amount of displacement of the central part was 59.1 μm.

—Results—

As is apparent from the above simulation, it is found that, compared with the comparative example, the present invention can performing opening and closing against 5 or more times the differential pressure. It is found that the amount of free displacement in the central part according to the present invention is approximately twice that in the comparative example.

FIG. 15 illustrates a second example of the piezoelectric element. The piezoelectric element 21A of this example is also a bimorph actuator having two single-panel piezoelectric bodies 21a and 21b composed of piezoelectric ceramic, as in the case of FIG. 13. The interlayer electrodes and the surface electrodes are the same as in the example of FIG. 13, except that the polarization direction is different. That is, the polarization direction in the first region S1 and that in the second region S2 (indicated by the arrows P) within the same piezoelectric body are opposite, and the two piezoelectric body layers 21a and 21b are polarized in the same direction. As illustrated in FIG. 15 with the plus and minus signs, when a direct-current voltage is applied between the interlayer electrodes and the surface electrodes, the first region S1 and the second region S2 can bend and change their shapes oppositely, as in the case of the first example. In this example, because the same potential is present within a plane during driving, there is less possibility of shorts caused by migration. Additionally, conducting between electrodes is simple. The outermost surface can be grounded.

FIG. 16 illustrates a third example of the piezoelectric element. The polarization direction P and the configuration of the surface electrodes in the piezoelectric element 21B of this example are substantially the same as in the second example, but the piezoelectric element 21B is different in that an interlayer electrode 24 is a continuous (solid) electrode. That is, even when the interlayer electrode 24 is a solid electrode extending across the first region S1 and second region S2, as long as the surface electrodes 22a and 23a and 22c and 23c are separate electrodes, polarization can be performed properly, and, when a voltage is applied as indicated by the plus and minus signs illustrated in FIG. 16, the first region S1 and the second region S2 can bend and be displaced oppositely.

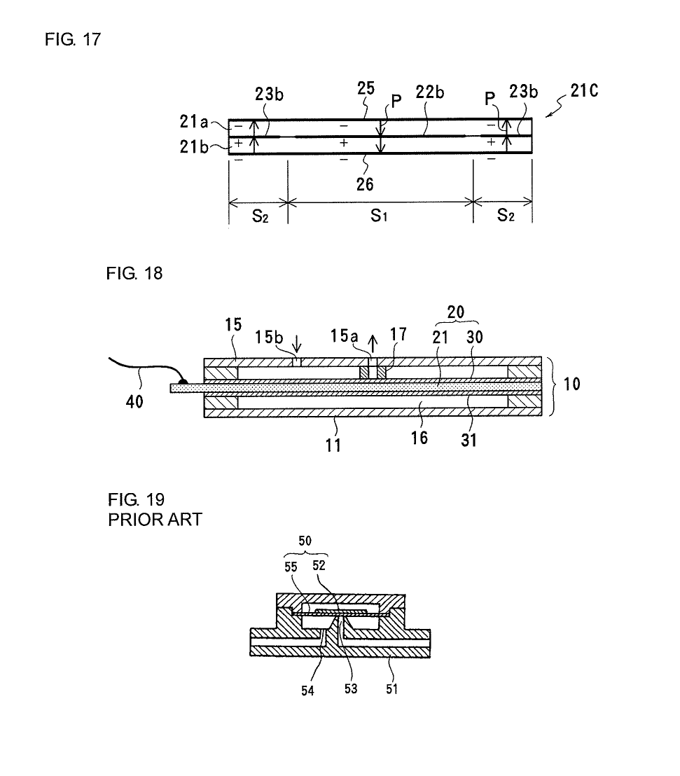

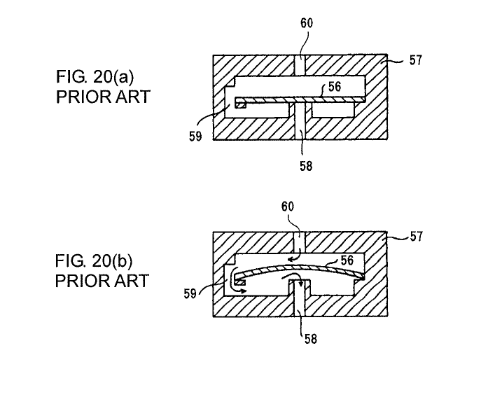

FIG. 17 illustrates a fourth example of the piezoelectric element. The piezoelectric element 21C in this example is a variation of the third example. The polarization direction P and the configuration of the surface electrodes are substantially the same as in the second example, but the piezoelectric element 21C is different in that surface electrodes 25 and 26 are continuous (solid) electrodes. Also in this case, because the interlayer electrodes 22b and 23b are separate electrodes, even when the surface electrodes 25 and 26 are continuous (solid) electrodes, polarization can be performed properly, and, when a voltage is applied as indicated by the plus and minus signs illustrated in FIG. 17, the first region S1 and the second region S2 can bend and be displaced oppositely.

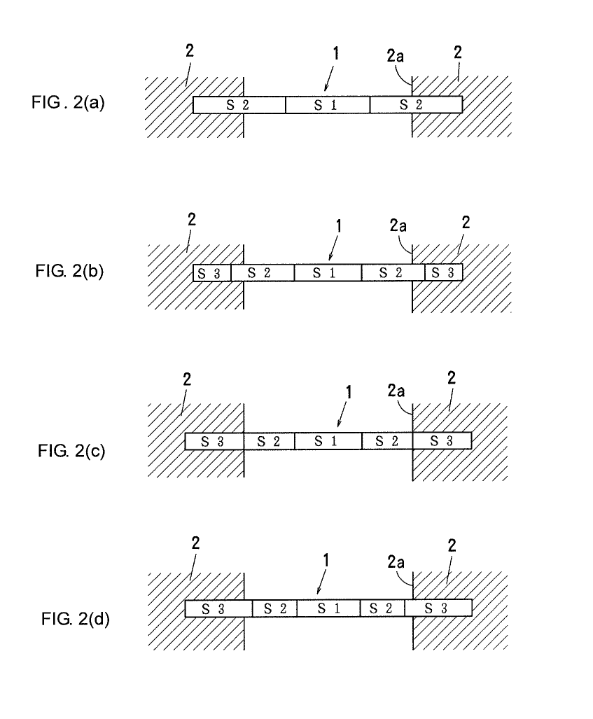

The piezoelectric elements illustrated in FIGS. 13 and 15 to 17 are an example in which the second region S2 extends to both ends thereof in the length direction. As illustrated in FIGS. 2(b) to 2(d), the intermediate region S3 may be formed on both ends in the length direction and outside the second region S2.

### Example 3

FIG. 18 illustrates an Example 3 of the piezoelectric valve according to the present invention. FIG. 5 illustrates an example in which the outlet 15a is open when no voltage is applied to the piezoelectric element 21 (normally open type). In this example, the outlet 15a is closed when no voltage is applied to the piezoelectric element 21 (normally close type). In this case, the piezoelectric element 21 may be fixed on the valve body 10 while being slightly bent to some degree such that the piezoelectric element 21 is pressed in contact with the valve sheet 17 when no voltage is applied. When a voltage is applied to the piezoelectric element 21 in a direction in which the piezoelectric element 21 bends convexly downwardly, the piezoelectric element 21 becomes separated from the valve sheet 17, so the outlet 15a can be opened. The channel opening opened and closed by the piezoelectric element 21 is not limited to the outlet 15a and may be the inlet 15b.

The present invention is not limited to the examples described above, and various modifications are possible. In the above-described examples, the rectangular piezoelectric element is used, and both ends thereof in the length direction are fixed by the valve body. However, a disc-shaped or track-shaped piezoelectric element may be used, and its periphery may be fixed by the valve body. In this case, the first region may be provided in the central part, and the second region may be provided in the outer area.

In the above-described examples, the two piezoelectric body layers are laminated to form the piezoelectric element. However, three or more piezoelectric body layers may be laminated. Increasing the number of laminated layers can increase a driving force. In the case of a piezoelectric element having an odd number of layers, the piezoelectric element may have a reinforcement layer that is not polarized or is polarized but is not derived in the central part in the lamination direction of the piezoelectric element to relieve stress occurring in bending.

In the piezoelectric element in the above-described examples, piezoelectric bodies that have been sintered and polarized in advance are laminated and bonded. However, the piezoelectric bodies being a ceramic green sheet may be laminated and crimped, and after sintering, they may be polarized. In this case, because the piezoelectric body layers can be thinner, the voltage to be applied can be smaller.

The valve body is not limited to the above-mentioned examples, which plate members are laminated and bonded above and below. Recessed case members are preliminarily formed and they may be bonded face to face putting piezoelectric element between them as a valve body.

The piezoelectric valve of the present invention is compact size and low-profile. Therefore, it is efficient as a active valve which is used at a fuel pipeline in fuel cell of mobile device such as a personal computer and so on and a circulation pathway of cooling water and so on. In this regard, it is not limited to these applications.

1. A piezoelectric valve comprising:
a valve body having an open/close channel opening; and
a valve member including a plate piezoelectric element that is bent in a thickness direction thereof by application of a voltage thereto so as to open and close the open/close channel opening by bending,
wherein each of both ends or an outer area of the piezoelectric element is fixedly held by the valve body,
the piezoelectric element has a first region in a central part or a center and a second region adjacent to the both ends or the outer area, and
the first region and the second region are configured so as to be bent and displaced oppositely by the voltage applied to the piezoelectric element.

2. The piezoelectric valve according to claim 1, wherein the piezoelectric element has a rectangular shape,
both ends of the piezoelectric element in a length direction thereof are fixedly held by the valve body,
a communicating portion for fluid is disposed between opposed sides of the piezoelectric element in a width direction, and
a region adjacent to a front side of the piezoelectric element and a region adjacent to a back side thereof communicate with each other thorough the communicating portion.

3. The piezoelectric valve according to claim 2, wherein the first region is located in a central part of a portion of the piezoelectric element in the length direction, the portion being not fixed by the valve body, the second region is located closer to the both ends of the piezoelectric element in the length direction than the first region, and the first region opens and closes the open/close channel opening.

4. The piezoelectric valve according to claim 2, wherein an intermediate region is located in the both ends of the piezoelectric element in the length direction and closer to the ends in the length direction than the second region, the intermediate region being not bent and displaced spontaneously, and the intermediate region is fixedly held by the valve body.

5. The piezoelectric valve according to claim 2, wherein the valve body comprises:
a bottom board having a rectangular planar shape wider than the piezoelectric element;
a first frame disposed on an upper surface of the bottom board and having a rectangular frame shape and an inner width dimension larger than that of the piezoelectric element;
a pair of retainer plates disposed on an upper surface of the first frame in the width direction and having substantially the same thickness as the piezoelectric element;
a second frame disposed on an upper surface of the piezoelectric element and on the pair of retainer plates, and having substantially the same shape as the first frame; and
a top board disposed on an upper surface of the second frame,
wherein the both ends of the piezoelectric element in the length direction are sandwiched between both ends of the first frame and the second frame in the length direction, the bottom board, the first frame, the piezoelectric element, the retainer plates, the second frame, and the top board are laminated together so that a valve chamber for allowing the piezoelectric element to be displaced is present between the bottom board and the top board.

6. The piezoelectric valve according to claim 1, wherein at least a surface of the piezoelectric element facing a space of the valve body through which fluid passes is covered with a protective layer that does not substantially constrain the displacement of the piezoelectric element.

7. The piezoelectric valve according to claim 6, wherein the protective layer includes a pair of upper and lower films bonded such that the piezoelectric element is disposed therebetween.

8. The piezoelectric valve according to claim 2, wherein at least a surface of the piezoelectric element facing a space of the valve body through which fluid passes is covered with a protective layer that does not substantially constrain the displacement of the piezoelectric element.

9. The piezoelectric valve according to claim 8, wherein the protective layer includes a pair of upper and lower films bonded such that the piezoelectric element is disposed therebetween.

10. The piezoelectric valve according to claim 9, wherein each of the upper and lower films has a slit forming the communicating portion at a portion extending along the both side parts of the piezoelectric element in the width direction.

11. The piezoelectric valve according to claim 2, wherein the valve body comprises:
a bottom board having a rectangular planar shape wider than the piezoelectric element;
a first frame disposed on the bottom board and having a rectangular frame shape and an inner width dimension larger than that of the piezoelectric element;
a first protective board disposed on the first frame, having a pair of slits in an area extending along the both side parts of the piezoelectric element in the width direction;
the piezoelectric element disposed on a central upper surface of the first protective board;
a pair of retainer plates disposed on the first protective board and in the vicinity of the both side parts of the piezoelectric element in the width direction, having slits corresponding to the slits of the first protective board, and having a thickness substantially the same as the piezoelectric element;
a second protective board disposed on the piezoelectric element and the retainer plates and having the same shape as the first protective board;
a second frame disposed on the second protective board and having substantially the same shape as the first frame; and
a top board disposed on the second frame,
wherein the both ends of the piezoelectric element in the length direction are sandwiched between both ends of the first frame and the second frame in the length direction with the first and second protective board, and
the bottom board, the first frame, the first protective board, the piezoelectric element, the retainer plates, the second protective board, the second frame, and the top board are laminated in sequence and bonded.

12. The piezoelectric valve according to claim 1, wherein the piezoelectric element is a bimorph actuator having electrodes on each side of two single-panel piezoelectric bodies.

13. The piezoelectric valve according to claim 12, wherein the two single-panel piezoelectric bodies are polarized in the same direction.

14. The piezoelectric valve according to claim 12, wherein the two single-panel piezoelectric bodies have regions that are polarized in opposite directions.

15. The piezoelectric valve according to claim 12, wherein each of the electrodes includes a central electrode portion and end electrode portions.

16. The piezoelectric valve according to claim 12, wherein at least one of the electrodes is a continuous electrode.
